(19) United States
(12) Patent Application Publication
(10) Pub. No.: US 2003/0023850 A1
(43) Pub. Date: Jan. 30, 2003

(54) Verifying messaging sessions by digital signatures of participants

(75) Inventors: Michael Wayne Brown, Georgetown, TX (US); Rabindranath Dutta, Austin, TX (US); Michael A. Paolini, Austin, TX (US)

Correspondence Address: Marilyn Smith Dawkins, International Business Machines Corporation, Intellectual Property Law Department, 11400 Burnet Road., Internal Zip 4054, Austin, TX, 78758, US

(73) Assignee: International Business Machines Corporation, Armonk, NY

(21) Appl. No.: 09/915,511

(22) Filed: Jul. 26, 2001

(51) Int. Cl. H04L 9/00

(52) U.S. Cl. 713/176

(57) ABSTRACT

A method, system and program for saving logfiles of a messaging session with the digital signatures of participants in the messaging session is provided. A selection of message entries from a messaging session are recorded, wherein multiple users are participating in the messaging session. Digital signatures associated with the users are attached to the recording of the selection of message entries from the messaging session, such that an identity associated with each digital signature is verifiable for the recording of the messaging session.

### CROSS-REFERENCE TO RELATED APPLICATIONS

The present application is related to the following copending applications, which are filed on even date herewith and incorporated herein by reference:

(1) U.S. patent application Ser. No.__/______ (Attorney Docket No. AUS920010391US1);

(2) U.S. patent application Ser. No.__/______ (Attorney Docket No. AUS920010392US1);

(3) U.S. patent application Ser. No. __/______ (Attorney Docket No. AUS920010393US1);

(4) U.S. patent application Ser. No. __/______ (Attorney Docket No. AUS920010394US1);

(5) U.S. patent application Ser. No. __/______ (Attorney Docket No. AUS920010396US1);

(6) U.S. patent application Ser. No. __/______ (Attorney Docket No. AUS920010397US1); and

(7) U.S. patent application Ser. No. __/______ (Attorney Docket No. AUS920010553US1).

### BACKGROUND OF THE INVENTION

1. Technical Field:

The present invention relates in general to electronic communications and, in particular, to recording messaging sessions. Still more particularly, the present invention relates to attaching digital signatures for each participant to a recording of a messaging session, such that the identities of participants in the messaging session and the integrity of the recorded messaging session may be verified.

2. Description of the Related Art:

As the Internet and telephony expand, the ease of communications between individuals in different locations continues to expand as well. One type of electronic communication is supported by messaging which includes the use of computer systems and data communication equipment to convey messages from one person to another, as by e-mail, voice mail, unified messaging, instant messaging, or fax.

While electronic mail (e-mail) has already expanded into nearly every facet of the business world, other types of messaging continue to forge into use. For example, instant messaging systems are typically utilized in the context of an Internet-supported application that transfers text between multiple Internet users in real time.

In particular, the Internet Relay Chat (IRC) service is one example of instant messaging that enables an Internet user to participate in an on-line conversation in real time with other users. An IRC channel, maintained by an IRC server, transmits the text typed by each user who has joined the channel to the other users who have joined the channel. An IRC client shows the names of the currently active channels, enables the user to join a channel, and then displays the other channel participant's words on individual lines so that the user can respond.

Similar to IRC, chat rooms are often available through on-line services and provide a data communication channel that links computers and permits users to converse by sending text messages to one another in real-time.

For typical telephone systems, regulations often require that a notification be provided to callers when a telephone conversation is being recorded by one of the parties. For example, a beep tone repeated at an interval throughout a conversation is often an indication that the conversation is being recorded. In another example, a notification such as “This conversation may be recorded” may be utilized to notify callers that a conversation is being recorded.

Instant messaging sessions continue to replace and/or supplement telephone conversations in business and personal contexts. For example, while a user is logged onto a web site, the user may converse with technical personnel or personal shoppers via an instant messaging session.

However instant messaging systems are limited in that there is not a method to verify the identities of users participating in a messaging session beyond the textual labels associated in a messaging session with message entries. For example, where a consumer communicates with technical personnel via an instant messaging session, there is not a method to verify the identities of the consumer and the technical personnel in the session for business or legal purposes if the messaging session is saved. Further, instant messaging systems are limited in that there is not a method to verify the integrity of the saved messaging session contents.

In view of the foregoing, it would be advantageous to provide a method, system and program for recording and saving messaging sessions where the identities of the users participating in the messaging session and the content of the messaging session are verifiable.

### SUMMARY OF THE INVENTION

In view of the foregoing, it is therefore an object of the present invention to provide an improved method, system and program for performing electronic communications.

It is another object of the present invention to provide a method, system and program for recording messaging sessions.

It is yet another object of the present invention to provide a method, system and program for attaching digital signatures for each participant to a recording of a messaging session, such that the identities of participants in the messaging session and the integrity of the recorded messaging session may be verified.

According to one aspect of the present invention, a selection of message entries from a messaging session are recorded, wherein multiple users are participating in the messaging session. Digital signatures associated with the users are attached to the recording of the selection of message entries from the messaging session, such that the messaging session is verifiable.

According to another aspect of the present invention, a digital signature for a sender of a message entry is attached to said message entry. The message entry is then distributed to a multiple participants in a messaging session, wherein each of the participants in the messaging session are enabled to verify the message entry with the digital signature in real-time.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIG. 2 illustrates a simplified block diagram of a client/server environment in which electronic messaging typically takes place in accordance with the method, system and program of the present invention;

FIG. 3 depicts a block diagram of one embodiment of a messaging server in accordance with the method, system and program of the present invention;

FIG. 4 illustrates a graphical representation of a messaging session interface in accordance with the method, system and program of the present invention;

FIG. 5 depicts a block diagram of an example of a log file with digital signatures attached in accordance with the method, system, and program of the present invention;

FIG. 6 illustrates a high level logic flowchart of a process and program for controlling recording and attachment of digital signatures to messaging sessions in accordance with the method, system, and program of the present invention; and

FIG. 7 depicts a high level logic flowchart of a process and program for controlling a client messaging system in accordance with the method, system and program of the present invention.

### DETAILED DESCRIPTION OF THE PREFERRED EMBODIMENT

A method, system and program are provided for attaching digital signatures to a recording of a messaging session such that the identities of participants in the messaging session and the integrity of the messaging session may be verified. A “messaging session” preferably includes, but is not limited to, any combination of voice, graphical, video, and/or text messages, instant and/or delayed, transmitted between multiple users via a network. Messaging sessions may include use of chat rooms, instant messages, e-mail, IRC, conference calling and other network methods of providing a channel for users to communicate within. Further, messaging sessions may include communications such as voice, video, and text transmissions between multiple telephony devices.

A “digital signature” may encompass multiple types of encryption methods utilized to verify the authenticity of signatures and the integrity of documents. In a preferred embodiment, a combination of private key and public key technology is utilized for a digital signature, however, other types of encryption keys, hashing and encryption techniques may be utilized. In addition, a textual, graphical, video, or audio identification may be included with a digital signature.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Hardware Overview

The present invention may be executed in a variety of systems, including a variety of computing systems and electronic devices under a number of different operating systems. In one embodiment of the present invention, the messaging system is a portable computing system such as a notebook computer, a palmtop computer, a personal digital assistant, a telephone or other electronic computing system that may also incorporate communications features that provide for telephony, enhanced telephony, messaging and information services. However, the messaging system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

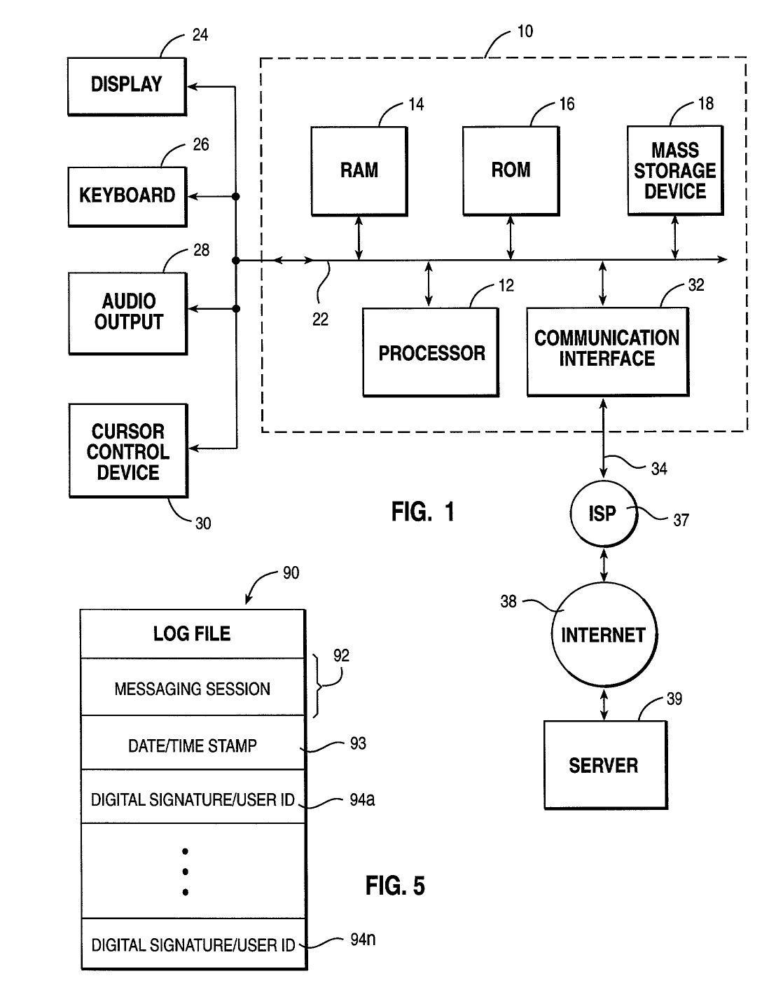

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

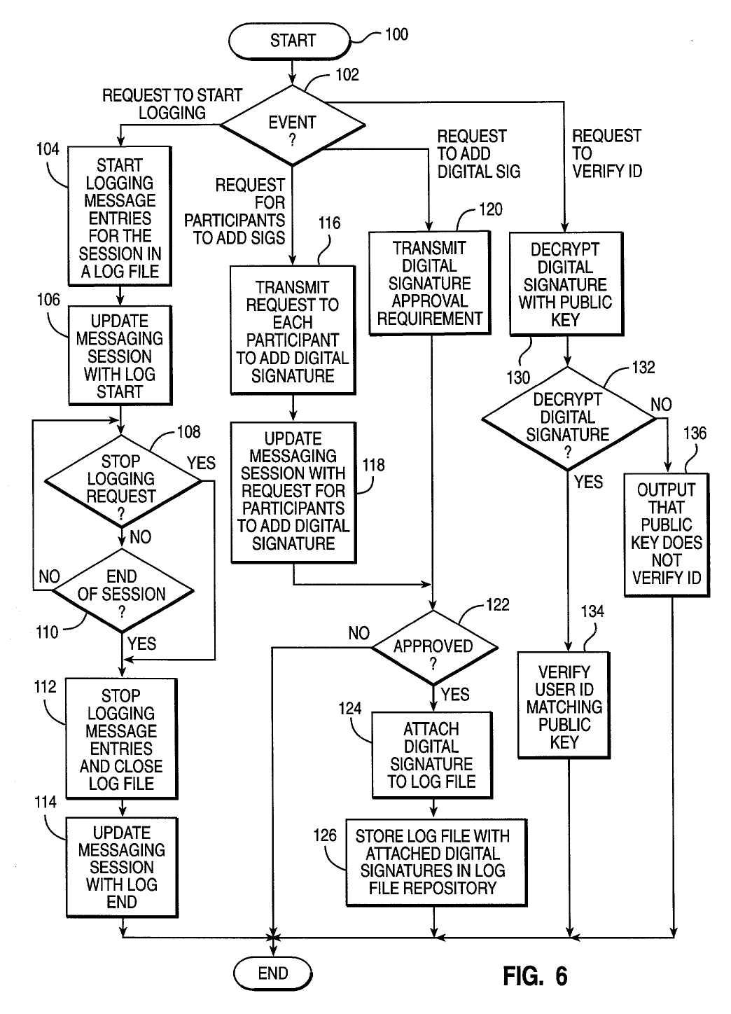

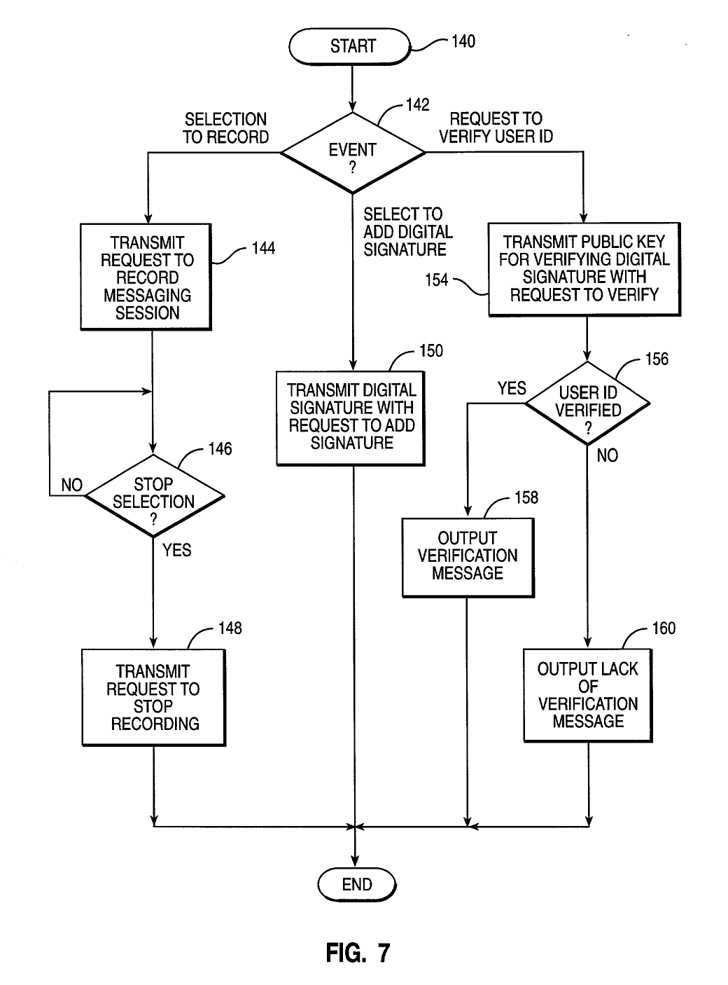

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowcharts of FIGS. 6, 7 and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patters of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of non-volatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. A keyboard 26 and cursor control device 30, such as a mouse, trackball, or cursor direction keys, are coupled to bus 22 as interfaces for user inputs to computer system 10. In alternate embodiments of the present invention, additional input and output peripheral components may be added.

### Messaging Systems Context

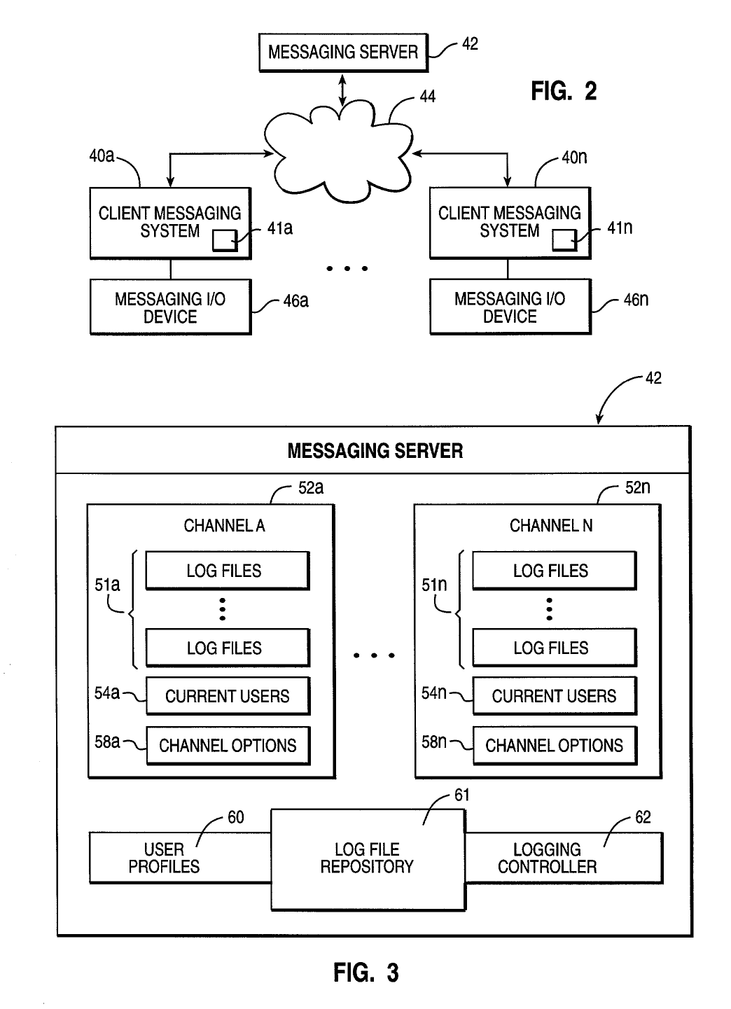

With reference now to FIG. 2, there is depicted a simplified block diagram of a client/server environment in which electronic messaging typically takes place in accordance with the method, system and program of the present invention. The client/server environment is implemented within multiple network architectures. For example, the architecture of the World Wide Web (the Web) follows a traditional client/server modeled environment.

The terms “client” and “server” are used to refer to a computer's general role as a requester of data (the client) or provider of data (the server). In the Web environment, web browsers such as Netscape Navigator typically reside on client messaging systems 40a-40n and render Web documents (pages) served by at least one messaging server such as messaging server 42. Additionally, each of client messaging systems 40a-40n and messaging server 42 may function as both a “client” and a “server” and may be implemented utilizing a computer system such as computer system 10 of FIG. 1. Further, while the present invention is described with emphasis upon messaging server 42 controlling a messaging session, the present invention may also be performed by client messaging systems 40a-40n engaged in peer-to-peer network communications via a network 44.

The Web may refer to the total set of interlinked hypertext documents residing on servers all around the world. Network 44, such as the Internet, provides an infrastructure for transmitting these hypertext documents between client messaging systems 40a-40n and messaging server 42. Documents (pages) on the Web may be written in multiple languages, such as Hypertext Markup Language (HTML) or Extensible Markup Language (XML), and identified by Uniform Resource Indicators (URIs) that specify the particular messaging server 42 and pathname by which a file can be accessed, and then transmitted from messaging server 42 to an end user utilizing a protocol such as Hypertext Transfer Protocol (HTTP). Web pages may further include text, graphic images, movie files, and sounds as well as Java applets and other small embedded software programs that execute when the user activates them by clicking on a link.

Advantageously, in the present invention, a client enters a message via one of messaging input/output (I/O) devices 46a-46n for a messaging session at a client messaging system such as client messaging system 40a. The message entry is transmitted to messaging server 42. Messaging server 42 then distributes the message entry to the user participating in the messaging session via network 44.

In addition, in the present invention, a user at each of client messaging systems 40a-40n may request to record or log a messaging session. Such requests are transmitted to messaging server 42. Messaging server 42 may then record the messaging session until the user at one of client messaging systems 40a-40n requests to stop logging. Then, the user may request at one of client messaging systems 40a-40n that other users participating in the messaging session attach a digital signature to the recording. The log file containing the recording may be stored at one or more of client messaging systems 40a-40n, at messaging server 42 or at another data storage system accessible via network 44.

Messaging server 42 transmits the request to attach a digital signature to the log file to the other client systems 40a-40n. When a user selects to attach a digital signature, in one embodiment, a unique security data packet is transmitted to messaging server 42. The unique security data packet includes a private key, public key and textual, graphical, video or audio signature. The private key may be a password-protected numerical value that allows the user to sign a document. The public key is embedded in the digital signature and is used to mathematically verify digital signatures when requested. The private key further encrypts a checksum determined for the contents log file that is stored with the signature. The public key decrypts the checksum utilized to verify the signature and the integrity of the log file.

While in the present embodiment messaging server 42 handles distribution of message entries and coordinates attachment of digital signatures to recorded messaging sessions, in alternate embodiments, recorded messaging sessions with digital signatures attached may be accessible to client messaging systems 40a-40n as files in a directory that is accessible to a user. In addition, the digital signature agreement requests and recorded messaging sessions with digital signatures attached may be transmitted as e-mail to participants in the messaging session. Moreover, the present invention may utilize a traditional IRC channel for transmitting message entries and a special IRC device channel opened in parallel with the traditional IRC channel for transmitting digital signature agreements and digital signatures. Furthermore, other types of messaging systems may be utilized to implement the present invention, as will be understood by one skilled in the art.

Advantageously, the steps of requesting to record, requesting to stop recording, and requesting that digital signatures be attached are performed by an application executing in each of client messaging systems 40a-40n, such as client recording applications 41a-41n. In addition, client recording applications 41a-41n may control attaching a digital signature to a log file.

Referring now to FIG. 3, there is illustrated a block diagram of one embodiment of a messaging server in accordance with the method, system and program of the present invention. As depicted messaging server 42 includes a logging controller 62 that is provided to control the process steps of messaging server 42 as will be further described.

Messaging server 42 also includes multiple channels 52a-52n. Each of channels 52a-52n may represent a separate information path within messaging server 42 in which multiple users may participate in a messaging session. Messaging server 42 may have a defined number of channels 52a-52n or may allow users to create new channels as needed. In particular, channels provide network paths between multiple users for both voice and text communications. Each of channels 52a-52n may further include multiple distinguishable topics.

In addition, each of channels 52a-52n preferably includes a table of current users 54a-54n. As a user selects to participate in channels 52a-52n, the user's identification is attached to the table of current users 54a-54n for that channel.

Preferably, as messaging server 42 receives messages, they may be stored according to the channel, topic and user and then distributed to each of the users participating in that channel. Where both voice and text are being utilized in a single messaging session, messaging server 42 may transmit both voice and text or messaging server 42 may translate all entries into either voice or text before distributing entries to the users participating in the channel.

Messaging entries are preferably stored within each channel in one of log files 51a-51n. Advantageously, multiple users may request to record different selections of the message entries for a messaging session where a new log file is utilized for each request. For example, one user may request to record message entries from a selection of users from among all the users while another user may request to record message entries during a particular time interval of the messaging session.

When a user has finished recording the desired portions of a messaging session, the log file for that user may be stored in a log file repository 61. Digital signatures may be attached to a log file before and after placement in log file repository 61.

Advantageously, log file repository 61 catalogs messaging session recordings such that multiple users may easily access the recordings. While in the present invention log file repository 61 is depicted within messaging server 42, in alternate s embodiments log file repository 61 may be included in an alternate server system. Alternatively, log files may be transmitted from messaging server 42 to client messaging systems for storage or may be logged in one of the client messaging systems during the messaging session.

Messaging server 42 includes a user profiles database 60 that includes profile information for each user, including, but not limited to, a user identification, a name, an e-mail address, signature data and a user history recorded as the user participates in messaging sessions. The user identification stored in user profiles 60 during registration is utilized across multiple channels for identifying entries provided by that user. The signature data may include the digital signature for a user that is utilized when authorized.

Channel options are included with each channel as depicted by channel options 58a-58n. Channel options preferably include signature requirements for recordings made in the channel. Advantageously, channel options may be selected when a user requests a new channel. Alternatively, a user may select a channel based on the digital signature requirements set in the channel options for that channel. Moreover, a business or other network service provider may automatically set channel options for channels.

Logging controller 62 is advantageously a software application executing within messaging server 42 in order to control the process of obtaining and attaching digital signatures to a log file. Further, logging controller 62 may control the process of verifying the participants and the integrity of messaging session recordings according to attached digital signatures. In particular, to verify the participants in a messaging session, logging controller 62 utilizes a public key for a user to attempt to decrypt the private key and checksum. If a private key matches a public key, then an identity for a user associated with the public and private keys may be verified. Further, logging controller 62 utilizes the public key to decrypt a checksum for the recorded messaging session and then computes a current checksum for the messaging session. If the checksums match, then the integrity of the messaging session may be verified. In addition, methods other than calculating a checksum may be utilized to verify the integrity of the messaging session.

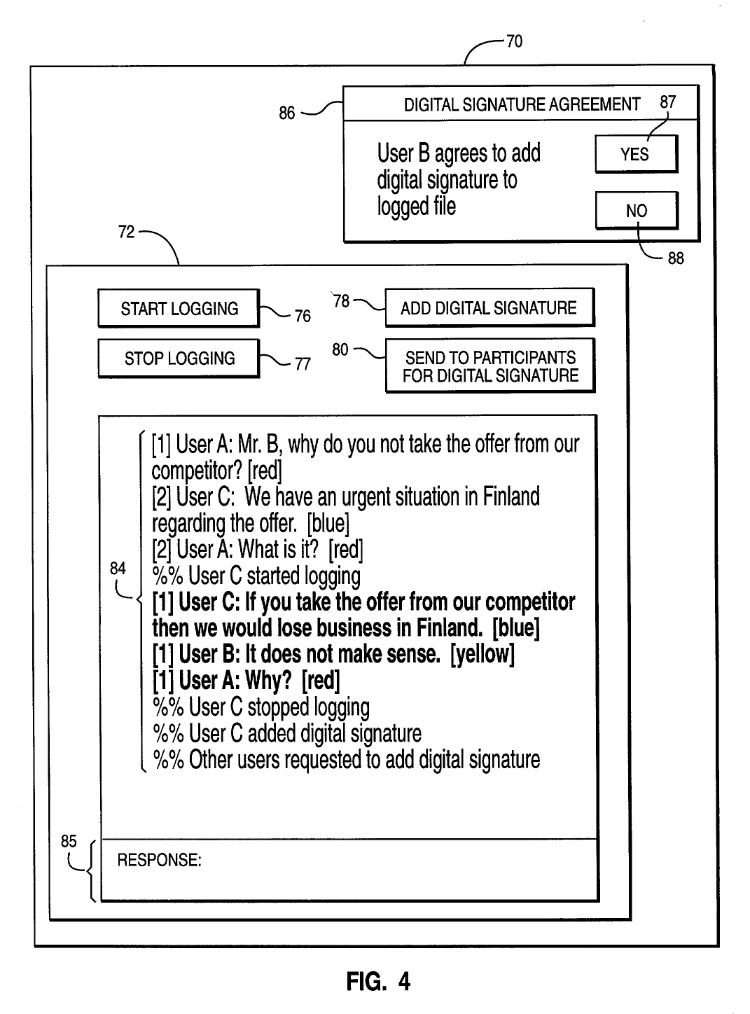

With reference now to FIG. 4, there is depicted a graphical representation of a messaging session interface in accordance with the method, system and program of the present invention. As depicted, a messaging session interface 70 includes a messaging session window 72 and a digital signature agreement window 86. For the present example, messaging session interface 70 is accessible to user B, however in alternate embodiments, alternate users may have access to messaging session 70.

Messaging session window 72 depicts selectable buttons 76 and 77. In response to a user selecting selectable button 76, a request to log the conversation is transmitted to the messaging server. In addition, in response to a user selecting selectable button 77, a request to stop logging the conversation is transmitted to the messaging server.

Messaging session entries 84 are also depicted within messaging session window 72. Messaging session entries 84 include message entries by users A, B, and C and textual references to logging activity by user C. As illustrated within messaging session entries 84, after user C requested to start logging, the message entries following are textually distinguishable in bold to indicate that the message entries are being recorded. Moreover, alternative types of indicators that message entries are being recorded may be utilized. For example, a graphical or audible indicator may be provided.

Further, messaging session entries 84 may be graphically distinguished according to user and according to topic. In the present example, message entries are distinguished by user by a color utilized to graphically display the entry as indicated within brackets. In addition, in the present example, topics are distinguished by a bracketed numeral such as “[1]” and “[2]”. In alternate embodiments, alternate types of graphical and audible characteristics may be utilized to distinguish entries by user and by topic.

A response block 85 is also illustrated within messaging session window 72. Response block 85 is provided to allow a user to enter a textual, graphical, audible or other message to be included in the messaging session.

Messaging session window 72 further includes selectable buttons 78 and 80. In response to a user selection of selectable button 78, that user's digital signature is transmitted to the messaging server to be attached to a log file. The log file that the digital signature is attached to may be one requested to be recorded by the user or may be a log file that another user requested to be recorded. Alternatively, in response to a user selection of selectable button 78, an authorization may be transmitted to the messaging server to utilize a digital signature stored with the user's identification at the messaging server.

In response to a user selection of selectable button 80, a request is transmitted to the messaging server to send a request to other participants to attach a digital signature to the log file. As a result, the messaging server may transmit a digital signature agreement request that is output in a manner such as digital signature agreement request window 86.

Digital signature agreement request window 86 includes a textual agreement that “User B agrees to attach a digital signature to the logged file”. In response to user B selecting selectable button 87, an agreement to attach user B's digital signature is returned to the messaging server. Alternatively, in response to user B selecting selectable button 88, a lack of agreement to attaching user B's digital signature is returned to the messaging server.

In particular, when a user agrees to attach a digital signature to a log file, the digital signature may be transmitted from the client system to the messaging server to be attached to a log file. Or, in another alternative, the digital signature may be stored at the messaging server such that the agreement permits the digital signature to be released for attachment to the log file.

As an alternative to a digital signature agreement request, a user may select in signature data associated with the user's identification to automatically agree to attach a digital signature to a log file if specified conditions are met. For example, a user may specify that a digital signature is to be applied any time a request is transmitted by a particular group of users. Moreover, a user may specify a group of users to whom requests to attach a digital signature are not agreed to.

Further, while the present invention is described with emphasis upon attaching digital signatures to log files, a user may also request to attach a digital signature to an individual message entry as it is transmitted to other messaging systems. By transmitting an individual message entry with a digital signature attached, users participating in the messaging session may verify the identity of the user transmitting the user message entry and the integrity of the message entry by providing the public key for the user transmitting the entry. In particular, a client messaging system may decrypt and verify the identity and integrity of a message entry received in real-time with a digital signature attached. Advantageously, by attaching digital signatures to message entries in real-time, an additional level of security is added to a messaging session.

Referring now to FIG. 5, there is depicted a block diagram of an example of a log file with digital signatures attached in accordance with the method, system, and program of the present invention. As illustrated, a log file 90 includes a session block 92, a time and date stamp 93 and digital signatures 94a-94n. Although not depicted, a message entry may also include a entry block, a time and data stamp, and at least one digital signature.

Session block 92 preferably includes the message entries recorded for a session. In particular, session block 92 may include textual, graphical and audible message entries recorded from a messaging session.

Next, time and data stamp 93 preferably includes the time period during which the messaging session was recorded and the dates of recording. Time and date stamp 93 may further include a log of the time and date of actual posting of each message entry recorded in session block 92.

Multiple digital signatures 94a-94n include a checksum encrypted by a private key and a graphical signature. In addition, a public key for decryption of the private key may be stored with each digital signature. As each user attaches a digital signature to log file 90, the digital signature is advantageously associated with a user identification, such that when the digital signature associated with the user identification is verified, the message entries associated with the user identification are also verified. In particular, the checksum is preferably calculated from messaging session 92 utilizing a checksum technique, as will be understood by one skilled in the art. The checksum encrypted by a private key may be decrypted by a particular matching public key.

With reference now to FIG. 6, there is illustrated a high level logic flowchart of a process and program for controlling recording, attachment, and verification of digital signatures to messaging sessions in accordance with the method, system, and program of the present invention. As depicted, the process starts at block 100 and thereafter proceeds to block 102. Block 102 illustrates a determination as to which event occurred when an event occurs. If a request to start logging is received, then the process passes to block 104. If a request for participants to attach signatures is received, then the process passes to block 116. Or, if a request to attach a digital signature by that user is received, then the process passes to block 120. Further, if a user requests to verify a digital signature attached to a recorded messaging session, then the process passes to block 130.

Block 104 depicts starting logging of message entries for the session in a log file. Next, block 106 illustrates updating the messaging session with an indication that logging has started. Thereafter, block 108 depicts a determination as to whether or not a stop logging request is received. If a stop logging request is received, then the process passes to block 112. If a stop logging request is not received, then the process passes to block 110. Block 110 depicts a determination as to whether or not an end of a session has been reached. If an end of a session has been reached, then the process passes to block 112. If an end of a session has not been reached, then the process passes to block 108.

Block 112 depicts stopping the logging of message entries for the messaging session and closing the log file. Next, block 114 illustrates updating the messaging session with an indicator that logging has ended and the process ends.

Block 116 illustrates textually updating the messaging session with a request for participants to attach digital signatures. Next, block 118 depicts transmitting a request to each participant in the messaging session to attach a digital signature and the process passes to block 122.

Block 120 depicts transmitting a digital signature approval request to the user requesting to attach a digital signature. Next, block 122 illustrates a determination as to whether or not an approval to attach a digital signature is received. If an approval is not received, then the process ends. If an approval is received, then the process passes to block 124.

Block 124 depicts attaching a digital signature to a log file. According to one embodiment of the present invention, attaching a digital signature to a log file requires calculating a checksum for the log file and encrypting the checksum with the private key such that a particular public key will decrypt the checksum. Next, block 126 illustrates storing the log file with attached digital signatures in a log file repository. Thereafter, block 127 depicts storing the public key in a shared file accessible to users participating in the messaging session or transmitting the public key to those users and the process ends. While the present process is described with emphasis upon attaching a digital signature to a log file, a user may also request to attach a digital signature to a message entry in real-time before distribution to other participants. Further, the client messaging system may perform the attachment of a digital signature to a message entry prior to transmission to a messaging server or other client messaging systems.

Block 130 illustrates decrypting the messaging session or encrypted portion thereof with a public key or other signature verification data. Next, block 132 depicts a determination as to whether decryption is successful. In determining whether the decryption is successful, first the public key utilized to verify the signature must match the public key for the digital signature. Second, to determine whether decryption was successful, the decrypted checksum must match a current checksum for the log file to verify that the contents of the log file have not been adjusted. If decryption is not successful, then the process passes to block 136. If the decryption is successful, then the process passes to block 134. Block 136 illustrates transmitting a message that the public key or checksum is not valid and the process ends. Block 134 depicts transmitting a message containing a verification of the user identification that matched to the public key by the decryption and the process ends. Further, the verification may be signed with a digital signature from the server to verify the source of the verification. The process of verifying the identity and integrity of a messaging session may be performed by a messaging server or a client messaging system.

With reference now to FIG. 7, there is depicted a high level logic flowchart of a process and program for controlling a client messaging system in accordance with the method, system and program of the present invention. As illustrated, the process starts at block 140 and thereafter proceeds to block 142. Block 142 depicts a determination as to which event occurred when an event occurs. If a request to record is selected, then the process passes to block 144. If a request to attach a digital signature is selected, then the process passes to block 150. Or, if a request to verify a user identity for a messaging session is selected, then the process passes to block 154.

Block 144 depicts transmitting a request to record a specified portion of a messaging session to a messaging server. Next, block 146 illustrates a determination as to whether or not a selection to stop recording is received. If a selection to stop recording is not received, then the process iterates at block 146. If a selection to stop recording is received, then the process passes to block 148. Block 148 depicts transmitting a request to stop recording to the messaging server and the process ends.

Block 150 illustrates transmitting an agreement to attach a digital signature and unique security data for a digital signature to a messaging server and the process ends. Alternatively, an agreement to attach a digital signature may be transmitted alone where the unique security data for a digital signature is stored at another location only accessible upon receipt of an agreement to attach.

Block 154 depicts transmitting a public key to a messaging server or other signature verification server. Next, block 156 depicts a determination as to whether or not a user identity is verified with the key. If a user identity is not verified, then the process passes to block 160. Block 160 illustrates outputting a non-verification message and the process ends. Otherwise, if a user identity is verified, then the process passes to block 158. Block 158 depicts outputting a verification message and the process ends. Alternatively, a log file with digital signatures attached may be stored at the client system or transmitted to the client system with public keys to verify digital signatures and checksums attached to the log file. Further, a message entry may be received with a digital signature attached rather than a log file, wherein the process is utilized to request verification of the identity of a sender and integrity of the message entry.

While the invention has been particularly shown and described with reference to a preferred embodiment, it will be understood by those skilled in the art that various changes in form and detail may be made therein without departing from the spirit and scope of the invention.

What is claimed is:

1. A method for recording a verifiable messaging session , said method comprising the steps of:
recording a selection of message entries from a messaging session, wherein a plurality of users are participating in said messaging session; and
attaching a plurality of digital signatures each separately associated with one from among said plurality of users to said recording of said selection of message entries from said messaging session, such that the messaging session is verifiable.

2. The method for recording a verifiable messaging session according to claim 1, said method further comprising the step of:
recording said selection of message entries and attaching said plurality of digital signatures at a messaging server system communicatively connected via a network to a plurality of client systems accessible to said plurality of users.

3. The method for recording a verifiable messaging session according to claim 1, said method further comprising the step of:
recording said selection of message entries and attaching said plurality of digital signatures at a client system communicatively connected via a network to a plurality of client systems accessible to said plurality of users.

4. The method for recording a verifiable messaging session according to claim 1, said method further comprising the step of:
verifying said messaging session, wherein verifying includes at least one of verifying at least one of said plurality of digital signatures and verifying an integrity of said messaging session.

5. The method for recording a verifiable messaging session according to claim 1, said method further comprising the step of:
transmitting a request to said plurality of users to each attach a digital signature to said recording of said selection of message entries from said messaging session.

6. The method for recording a verifiable messaging session according to claim 1, said method further comprising the step of:
storing a plurality of keys each associated with one from among said plurality of digital signatures such that said plurality of keys are accessible to said plurality of users for verifying said plurality of digital signatures.

7. The method for recording a verifiable messaging session according to claim 1, said step of attaching a plurality of digital signatures further comprising the steps of:
calculating a checksum for said recording of said selection of message entries from said messaging session; and
encrypting said checksum utilizing a private key for a particular digital signature from among said plurality of digital signatures, wherein a particular public key is enabled to decrypt said encrypted checksum.

8. The method for recording a verifiable messaging session according to claim 7, said method further comprising the step of:
verifying an integrity of said selection of said plurality of message entries by:
calculating a current checksum for said selection of said plurality of message entries;
decrypting said encrypted checksum with said particular public key; and
comparing said current checksum with said decrypted checksum, wherein said integrity is verified if said decrypted checksum matches said current checksum.

9. The method for recording a verifiable messaging session according to claim 1, said method further comprising the step of:
verifying a particular digital signature from among said plurality of digital signatures in order to verify a particular user from among said plurality of users associated with said particular digital signature.

10. The method for recording a verifiable messaging session according to claim 9, said step of verifying a particular digital signature from among a plurality of digital signatures, further comprising the steps of:
determining whether a public key received in order to verify said particular digital signature matches a public key coupled to said particular digital signature; and
in response to determining a match, verifying said particular user associated with said particular digital signature.

11. A system for recording a verifiable messaging session, said system comprising:
a server system communicatively connected to a network;
said server system further comprising:
means for recording a selection of message entries from a messaging session, wherein a plurality of users are participating in said messaging session; and
means for attaching a plurality of digital signatures each separately associated with one from among said plurality of users to said recording of said selection of message entries from said messaging session, such that the messaging session is verifiable.

12. The system for recording a verifiable messaging session according to claim 11, said system further comprising:
a logging controller for verifying said messaging session, wherein said verifying includes at least one of verifying at least one of said plurality of digital signatures and verifying an integrity of said messaging session.

13. The system for recording a verifiable messaging session according to claim 11, said system further comprising:
means for transmitting a request to said plurality of users to each attach a digital signature to said recording of said selection of message entries from said messaging session.

14. The system for recording a verifiable messaging session according to claim 11, said system further comprising:
a log file repository for storing a plurality of public keys each associated with one from among said plurality of digital signatures such that said plurality of public keys are accessible to said plurality of users for verifying said messaging session.

15. The system for recording a verifiable messaging session according to claim 11, said means for attaching a plurality of digital signatures further comprising:
means for calculating a checksum for said recording of said selection of message entries from said messaging session; and
means for encrypting said checksum utilizing a private key for a particular digital signature from among said plurality of digital signatures, wherein a particular public key is enabled to decrypt said encrypted checksum.

16. The system for recording a verifiable messaging session according to claim 15, said system further comprising:
means for verifying an integrity of said selection of said plurality of message entries by:
calculating a current checksum for said selection of said plurality of message entries;
decrypting said encrypted checksum with said particular public key; and
comparing said current checksum with said decrypted checksum, wherein said integrity is verified if said decrypted checksum matches said current checksum.

17. The system for recording a verifiable messaging session according to claim 11, said system further comprising:
means for verifying a particular digital signature from among said plurality of digital signatures in order to verify a particular user from among said plurality of users associated with said particular digital signature.

18. The system for recording a verifiable messaging session according to claim 17, said means for verifying a particular digital signature from among a plurality of digital signatures, further comprising:
means for determining whether a public key received in order to verify said particular digital signature matches a public key coupled to said particular digital signature; and
means for verifying said particular user associated with said particular digital signature, in response to determining a match.

19. A program for recording a verifiable messaging session, residing on a computer usable medium having computer readable program code means, said program comprising:
means for enabling recording of a selection of message entries from a messaging session, wherein a plurality of users are participating in said messaging session; and
means for attaching a plurality of digital signatures each separately associated with one from among said plurality of users to said recording of said selection of message entries from said messaging session, such that the messaging session is verifiable.

20. The program for recording a verifiable messaging session according to claim 19, said program further comprising:
means for enabling verification of said messaging session, wherein verifying includes at least one of verifying at least one of said plurality of digital signatures and verifying an integrity of said messaging session.

21. The program for recording a verifiable messaging session according to claim 19, said program further comprising:
means for controlling transmission of a request to said plurality of users to each attach a digital signature to said recording of said selection of message entries from said messaging session.

22. The program for recording a verifiable messaging session according to claim 19, said program further comprising:
means for enabling storage of a plurality of keys each associated with one from among said plurality of digital signatures such that said plurality of keys are accessible to said plurality of users for verifying said plurality of digital signatures.

23. The program for recording a verifiable messaging session according to claim 19, said means for attaching a plurality of digital signatures further comprising:
means for calculating a checksum for said recording of said selection of message entries from said messaging session; and
means for enabling encryption of said checksum utilizing a private key for a particular digital signature from among said plurality of digital signatures, wherein a particular public key is enabled to decrypt said encrypted checksum.

24. The program for recording a verifiable messaging session according to claim 23, said program further comprising:
means for verifying an integrity of said selection of said plurality of message entries by:
calculating a current checksum for said selection of said plurality of message entries;
decrypting said encrypted checksum with said particular public key; and
comparing said current checksum with said decrypted checksum, wherein said integrity is verified if said decrypted checksum matches said current checksum.

25. The program for recording a verifiable messaging session according to claim 19, said program further comprising:
means for verifying a particular digital signature from among said plurality of digital signatures in order to verify a particular user from among said plurality of users associated with said particular digital signature.

26. The program for recording a verifiable messaging session according to claim 25, said program further comprising:
means for determining whether a public key received in order to verify said particular digital signature matches a public key coupled to said particular digital signature; and
means for verifying said particular user associated with said particular digital signature, in response to determining a match.

27. A method for transmitting verifiable message entries in a messaging session, said method comprising the steps of:
attaching a digital signature for a sender of a message entry to said message entry; and
distributing said message entry to a plurality of participants in a messaging session, wherein each of said plurality of participants in said messaging session are enabled to verify said message entry with said digital signature in real-time.

28. The method for transmitting verifiable message entries according to claim 27, said method further comprising the step of:
attaching said digital signature for said sender at a client messaging system before distribution within a network.

29. The method for transmitting verifiable message entries according to claim 27, said method further comprising the step of:
attaching said digital signature for said sender at a messaging server before distribution to said plurality of participants.

30. The method for transmitting verifiable message entries according to claim 27, said method further comprising the step of:
verifying at least one of an identity of said sender and an integrity of content of said message entry.

31. A system for transmitting verifiable message entries in a messaging session, said system comprising:
a messaging system communicatively connected to a network;
said messaging system further comprising:
means for attaching a digital signature for a sender of a message entry to said message entry; and
means for distributing said message entry to a plurality of participants in a messaging session, wherein each of said plurality of participants in said messaging session are enabled to verify said message entry with said digital signature in real-time.

32. The system for transmitting verifiable message entries according to claim 31, said system further comprising:
means for attaching said digital signature for said sender at a client messaging system before distribution within a network.

33. The system for transmitting verifiable message entries according to claim 31, said system further comprising:
means for attaching said digital signature for said sender at a messaging server before distribution to said plurality of participants.

34. The system for transmitting verifiable message entries according to claim 31, said system further comprising:
means for verifying at least one of an identity of said sender and an integrity of content of said message entry.

35. A program for transmitting verifiable message entries in a messaging session, residing on a computer usable medium having computer readable program code means, said program comprising:
means for enabling attachment of a digital signature for a sender of a message entry to said message entry; and
means for controlling distribution of said message entry to a plurality of participants in a messaging session, wherein each of said plurality of participants in said messaging session are enabled to verify said message entry with said digital signature in real-time.

36. The program for transmitting verifiable message entries according to claim 35, said program further comprising:
means for enabling attachment of said digital signature for said sender at a client messaging system before distribution within a network.

37. The program for transmitting verifiable message entries according to claim 35, said program further comprising:
means for enabling attachment of said digital signature for said sender at a messaging server before distribution to said plurality of participants.

38. The program for transmitting verifiable message entries according to claim 35, said program further comprising:
means for verifying at least one of an identity of said sender and an integrity of content of said message entry.
